(19) United States
(12) Patent Application Publication
(10) Pub. No.: US 2007/0248759 A1
(43) Pub. Date: Oct. 25, 2007

(54) Processes for producing articles containing titanium dioxide possessing low sinterability

(76) Inventor: Kostantinos Kourtakis, Media, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/788,412

(22) Filed: Apr. 20, 2007

Related U.S. Application Data
(60) Provisional application No. 60/793,958, filed on Apr. 20, 2006.

(51) Int. Cl. B05D 3/02; C03B 29/00; B32B 18/00

(52) U.S. Cl. 427/372.2; 428/702; 156/89.11

(57) ABSTRACT

Provided are processes for producing articles containing low sinterability titanium dioxide pigment. A low sinterability titanium oxide (powder) is desirable as an ingredient in moisture resistant printed circuit boards, ceramic substrates with high dimensional stability and ceramic layers which resist sintering with adjacent layers. According to the processes disclosed herein, low sinterability titanium dioxide can be produced by introducing silicon during the oxidation of titanium chloride in the chloride process of titanium dioxide production.

### FIELD OF THE INVENTION

The present invention is directed to processes for producing titanium dioxide possessing diminished sintering, and articles made therefrom.

### BACKGROUND

Akihiro (JP2001210951) describes a multilayer ceramic circuit board with moisture resistance and controlled surface contraction. Two or more green sheets of glass ceramic material containing a binder are laminated together. Green sheets on the surface of the laminated object contain low sinterability material.

Sata and Okazaki (JP2001158670) describe a method of restraining sintering contraction in the lamination of a glass ceramic green sheet. They obtain a glass ceramic substrate with high accuracy of dimension.

Rydinger, Fredriksson and Blaus (FR1376895) disclose a ceramic coating composition that resists sintering together with a ceramic substrate.

A need remains for low-sinterability titanium dioxide. A low-sinterability titanium dioxide powder is desirable as an ingredient in moisture resistant printed circuit boards, ceramic substrates with high dimensional stability and ceramic layers which resist sintering with adjacent layers.

### BRIEF DESCRIPTION OF THE DRAWINGS

FIG. 1 shows the particle size distribution of the material of example 1, produced by introducing a silicon halide precursor to the oxidation process of TiCl₄, followed by heating the oxide powder which is produced to 1150 C for 48 hours, and the particle size distribution of comparative example 1, which was prepared identically except for the introduction of the silicon halide precursor to the oxidation process.

### SUMMARY OF THE INVENTION

One aspect of the present invention is a process comprising:

a) in a chloride process for forming titanium dioxide, adding silicon halide precursor during oxidation of titanium tetrachloride to form silicon-containing titanium dioxide;
b) mixing the silicon-containing titanium dioxide with at least one binder and at least one solvent to form a slurry;
c) spreading the slurry with a doctor blade to form at least one green sheet;
d) laminating at least one green sheet with at least one green sheet of one or more other ceramic materials to form a laminated object containing a surface region of low sinterability material;
e) sintering the laminated object; and
f) removing the surface region of low sinterability material.
Another aspect of the present invention is a process comprising:
a) in a chloride process for forming titanium dioxide, adding silicon halide precursor during oxidation of titanium tetrachloride to form a silicon-containing titanium dioxide;
b) mixing the silicon-containing titanium dioxide with at least one binder and at least one solvent to form a slurry;
c) spreading the slurry with a doctor blade to form at least one green sheet;
d) laminating at least one green sheet with at least one green sheet; of one or more other ceramic materials to form a laminated object containing a surface region of low sinterability material;
e) sintering the laminated object; and
f) impregnating the surface region of low sinterability material with a resin.
a) in a chloride process for forming titanium dioxide, adding silicon halide precursor during oxidation of titanium tetrachloride to form a silicon-containing titanium dioxide;
b) mixing the silicon-containing titanium dioxide with at least one binder and at least one solvent to form a slurry;
c) coating the slurry on a substrate to form a coated substrate;
d) allowing the solvent to evaporate from the slurry to form a dried coated substrate; and
e) sintering the dried coated substrate.

### DETAILED DESCRIPTION

The processes disclosed herein can be used to produce low sinterability titanium dioxide powder and articles made therefrom.

According to the processes of the present invention, reduced sinterability titanium dioxide can be produced by a modification of the well-known chloride process. The chloride process for the production of titanium dioxide begins with chlorination of titanium ore to form titanium tetrachloride. The titanium tetrachloride is oxidized in the vapor phase to form titanium dioxide. The process is well known and described in U.S. Pat. Nos. 2,488,439 and 2,559,638 which are incorporated herein by reference. The introduction of SiCl₄ halide and its effect is disclosed in co-owned and co-pending patent application Ser. No. 11/407,736, the disclosures of which are hereby incorporated herein by reference in their entirety.

In the well-known chloride process, tetrachloride is evaporated and preheated to temperatures of from about 300 to about 650° C. and introduced into a reaction zone of a reaction vessel. TiO₂ produced by the chloride process contains some aluminum oxide. Aluminum halide such as AlCl₃, AlBr₃, and AlI₃, preferably AlCl₃, in amounts sufficient to provide about 0.5 to about 10% Al₂O₃, preferably about 0.5 to about 5%, and more preferably about 0.5 to about 2% by weight based on total solids formed in the oxidation reaction, is thoroughly mixed with titanium tetrachloride prior to its introduction into a reaction zone of the reaction vessel. In alternative embodiments, the aluminum halide may be added partially or completely with the silicon halide that is added downstream. An oxygen containing gas is preheated to at least 1200° C. and is continuously introduced into the reaction zone through a separate inlet from an inlet for the titanium tetrachloride feed stream. It is desirable that the reactants be hydrous. For example, the oxygen containing gas can comprise hydrogen as in H₂O and can range from about 0.01 to 0.3 wt. % hydrogen based on the total weight of titanium dioxide produced, preferably 0.02-0.2 wt. %. Optionally, the oxygen containing gas can also contain a vaporized alkali metal salt such as inorganic potassium salts, organic potassium salts and the like, particularly preferred are CsCl or KCl, to act as a nucleant.

Titanium dioxide made according to the processes disclosed herein contains particles that, when heated at high temperatures, exhibit a reduced tendency toward growth of particles that arises from the formation of strong particle interconnections or hard aggregates compared with conventional TiO₂ produced by the chloride process without silicon halide addition such growth is known in the art as sintering. A reduced tendency to sinter upon heating is desirable for titanium oxide used in some applications, particularly as an ingredient in processes for producing articles such as, for example, moisture resistant printed circuit boards, ceramic substrates with high dimensional stability and ceramic layers that resist sintering with adjacent layers. The present inventor has found that titanium dioxide exhibiting low sintering can be produced by introducing silicon halide precursor during the oxidation of titanium chloride in the chloride process used for titanium dioxide production. The titanium dioxide produced by a process according to the invention may be referred to herein as “reduced-sintering titanium dioxide” or “low sinterability titanium dioxide”, to contrast it with conventionally-made titanium dioxide.

In one embodiment, the silicon halide is introduced anywhere in the TiCl₄ stream prior to being mixed with oxygen. In some embodiments, the silicon halide is mixed with the aluminum halide prior to its introduction into the TiCl₄ stream. The silicon halide can be introduced either by directly injecting the desired silicon halide, or by forming the silicon halide in situ. When forming in situ, a silicon halide precursor is added to the TiCl₄ stream and reacted with a halide, for example, chlorine, iodine, bromine, or a mixture thereof to generate the silicon halide.

In an embodiment wherein the silicon halide is introduced anywhere in the TiCl₄ stream prior to being mixed with oxygen, the silicon halide is added to the TiCl₄ stream or formed in situ to add silicon oxide to the TiO₂ to create the low sinterability titanium dioxide product. In another embodiment, the silicon halide is added downstream from the TiCl₄ stream addition. The exact point of silicon halide addition will depend on the reactor design, flow rate, temperatures, pressures and production rates, but can be determined readily by testing to obtain mostly rutile TiO₂ and the desired effect. For example, the silicon halide may be added at one or more points downstream from where the TiCl₄ and oxygen containing gas are initially contacted.

In one embodiment for downstream addition, silicon halide is added downstream in a conduit or flue where scouring particles or scrubs are optionally added to minimize the buildup of TiO₂ in the interior of the flue during cooling as described in greater detail in U.S. Pat. No. 2,721,626, incorporated herein by reference. In this embodiment, the silicon halide can be added alone or at the same point with the sodium chloride scrubs which are used to clean the reactor walls in the chloride process. Specifically, the temperature of the reaction mass at the point or points of silicon halide addition is greater than about 1100° C., at a pressure of about 5-100 psig, in another embodiment 15-70 psig, and in another embodiment 40-60 psig. The downstream point or points of silicon halide addition can be up to a maximum of about 6 inside diameters of the flue after the TiCl₄ and oxygen are initially contacted.

As a result of mixing of the reactant streams, substantially complete oxidation of TiCl₄, AlCl₃ and silicon halide takes place but for conversion limitations imposed by temperature and thermochemical equilibrium. Solid particles of TiO₂ are formed, which contain small quantities of aluminum and silicon oxide. The reaction product containing a suspension of TiO₂ particles in a mixture of chlorine and residual gases is carried from the reaction zone at temperatures considerably in excess of 1200° C. and is subjected to fast cooling in the flue. The cooling can be accomplished by any standard method.

The TiO₂ powder containing aluminum and silicon oxide is recovered from the cooled reaction products by, for example, standard separation treatments, including cyclonic or electrostatic separating media, filtration through porous media, or the like. The recovered TiO₂ containing aluminum and silicon oxide may be subjected to surface treatment, milling, grinding, or disintegration treatment to obtain the desired level of agglomeration.

Silicon halide added becomes incorporated as silicon oxide and/or a silicon oxide mixture in the TiO₂, meaning that the silicon oxide and/or silicon oxide mixture is dispersed in the individual TiO₂ particles and/or on the surface of TiO₂ as a surface coating. In one embodiment, silicon halide is added in an amount sufficient to provide from about 0.1 to about 10% silicon oxide, in another embodiment about 0.3 to 5% silicon oxide, and in another embodiment about 0.3 to 3% silicon oxide by weight based on total solids formed in the oxidation reaction. Thus, the “low sinterability titanium dioxide” is predominantly titanium dioxide, but contains small quantities of silicon and aluminum oxides.

Suitable silicon halides include SiCl₄, SiBr₄, and SiI₄, preferably SiCl₄. The silicon halide can be introduced as either a vapor or liquid. In a preferred embodiment, the silicon halide is added downstream in the conduit or flue where scouring particles or scrubs are added to minimize the buildup of TiO₂ in the interior of the flue during cooling as described in U.S. Pat. No. 2,721,626, the teachings of which are incorporated herein by reference. In such embodiments, the silicon halide can be added alone or at the same point with the scrubs. In liquid silicon halide addition, the liquid is dispersed finely (atomizes into small droplets) vaporizes quickly; i.e., generally substantially instantaneously, within several seconds.

Titanium dioxide (containing silicon and aluminum oxide) having a reduced sinterability is desired for a variety of applications. Ceramic coatings on ceramic substrates for high temperature applications such as furnace doors are one such application. If the coating material contains reduced sinterability titanium dioxide, the coating has a reduced tendency to sinter to the underlying substrate. This approach can be used, for example, for replaceable linings of ceramic doors of furnaces. The coating of the low sinterability titanium dioxide can be mechanically removed from an underlying ceramic substrate when it becomes worn. The substrate can be subsequently recoated and returned to service.

In an exemplary application of titanium dioxide produced according to the processes disclosed herein and having a reduced tendency to sinter, TiO2 obtained via the chloride process with addition of silicon as outlined above is mixed, in powder form, with at least one binder and at least one solvent to form a slurry. Mixing can be accomplished with a ball mill, for example. Examples of useful binders are cellulose derivatives such as ethylhydroxy cellulose, carboxymethyl cellulose, and methyl cellulose, vinyl compounds polymerized such as polyvinyl alcohol and polyvinyl chloride, starch, dextrin, various types of resinous binders such as the melamine resins, urea resin and ester resin, etc. Solvents can be organic solvents such as, for example, non-protic solvents including tetrahydrofuran, toluene, and ketones.

After mixing, the resulting slurry is spread on a desired substrate. The substrate is usually a ceramic for high temperature applications. Spreading may be accomplished with a doctor blade or a brush or trowel. The slurry is then dried to allow the solvent to evaporate. After drying, the dried slurry is fired at a temperature of 900° C. to 1200° C. for a period of approximately one to twenty four hours. The low sinterability titanium dioxide tends not to sinter strongly to the substrate. This is useful in applications such as ceramic insulated doors to furnaces. The ceramic substrate forms the bulk of the insulation of the door and the coating forms the edge of the door. After wear in use, the low sinterable coating can be removed and replaced since in is not strongly bound to the substrate.

Dimensional stability during the sintering process can allow for fewer cracks when forming furnace heating elements. The reduced-sintering titanium dioxide can be used to constrain the contraction of another layer of material to be sintered The low sinterability titanium dioxide is prepared as described above, mixed with a binder and solvent and spread into a green sheet with a doctor blade. A green sheet comprises particles of ceramic in a polymer binder. The green sheet is frequently flexible enough to be shaped or positioned as desired. The green sheet of the low sinterability titanium dioxide is laminated with green sheets of other ceramic materials, such as metal carbides, oxide, nitrides, oxycarbides, oxynitrides, or mixtures thereof. The other ceramic material(s) can be, for example, selected from alumina, silicon carbide, silicon nitride, and zirconium oxide. Other technically important ceramics and mixtures of ceramics known to those skilled in the art can also be included. Usually several green sheets of other material are laminated with green sheets of the titanium dioxide laminated on the surface of the laminated object formed. For example, the laminated object may be a sandwich structure of two green sheets of other ceramic with two green sheets of titanium dioxide on the surface. The laminated object is then fired at 800 to 1200° C., in some embodiments preferably 800 to 1000° C., for one to twenty four hours. The low sinterability titanium dioxide green sheets form porous layers which do not contract very much during sintering. These layers constrain the contraction of the inner layers during firing, maintaining their dimensions. After firing, the porous outer layers may be mechanically removed, leaving the sintered inner layer or layers.

In a further embodiment, green sheets of low sinterability titanium dioxide are formed as disclosed above and laminated with a ceramic substrate, which may or may not be a green sheet of other material, to form a laminated object. The green sheets of low sinterability titanium dioxide are located on the surface of the laminated object. The laminated object is then fired at 800 to 1200° C. for one to twenty four hours, with 800 to 1000° C. preferred). This produces a fired object with porous outer layers. The porous outer layers may be impregnated with polymer resins to enhance moisture resistance, which is particularly desirable if other electronic structures have been embedded in the other layers prior to firing.

### EXAMPLE 1

TiCl₄ vapor containing vaporized AlCl₃ was heated and continuously admitted to the upstream portion of a vapor phase reactor of the type described in U.S. Pat. No. 3,203,763. Simultaneously, oxygen was heated to 1540° C. and admitted to the same reaction chamber through a separate inlet. Aluminum chloride was added at a rate sufficient to produce 1.1% Al₂O₃ on the collected oxidation reactor discharge. The reactant streams were rapidly mixed.

Silicon tetrachloride was then injected into the reaction mass downstream of the mixing location by the method described in U.S. Pat. No. 5,562,764. Silicon tetrachloride was added at a rate sufficient to generate 1.1% SiO₂ on the pigment. The gaseous suspension of powder, containing primarily TiO2 was then quickly cooled. The titanium dioxide containing product was separated from the cooled gaseous products by conventional means. The product was greater than 99.5% rutile phase.

Approximately 10 g of this powder was loaded into a zirconia ceramic boat and placed into a 4 inch diameter quartz tube in a horizontal tube furnace. An air flow rate of approximately 0.9 liters/minute was used during the heating cycle. The temperature was increased to 1150° C. at a rate of 5.5° C./minute. The powder was soaked at 1150° C. for 24 hours. Following this calcination cycle, the pigment was removed from the tube and ground lightly before being heated for another 24 hours. Following this procedure and prior to testing for abrasion, the powder was lightly ground to break up any large aggregates.

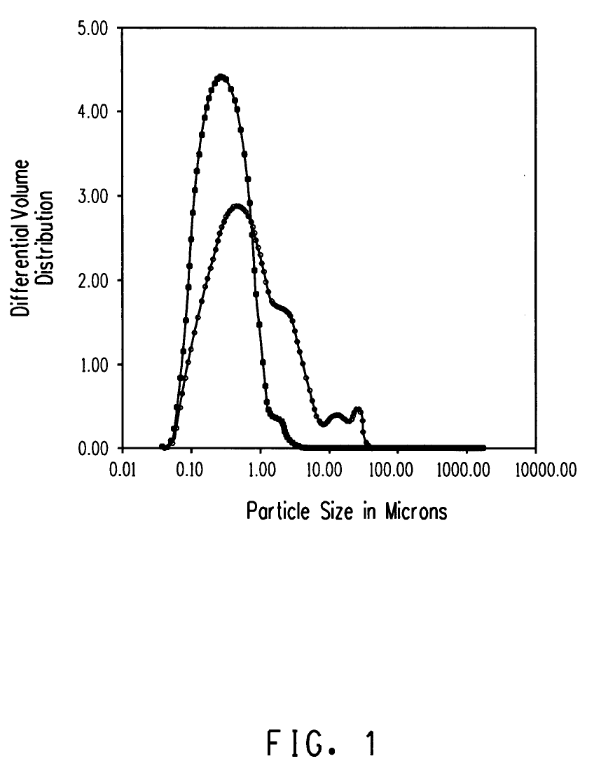

The particle size distribution was measured as a function of sonication time using a high energy horn with temperature control to prevent heating of the bath. In FIG. 1, the final particle size distribution is shown in pink at a sonication time of 10 minutes, where the particle size distribution no longer changes with sonication. The particle size distributions were measured with a Beckman Coulter LS230 which uses laser diffraction to determine the volume distribution of a field of particles. The samples were first mixed with 2 drops of Surfynol® GA, the diluted with 50 ml of 0.1% TSPP/H2O. The samples were then sonified until a stable particle size distribution was obtained, indicating that all loose aggregates have been broken apart. This is a measurement of the particle size distribution of primary pigment and strongly bound aggregates.

### COMPARATIVE EXAMPLE 1

A control sample which did not contain SiCl4 added to the TiCl4 oxidation process was generated. TiCl₄ vapor containing vaporized AlCl₃ was heated and continuously admitted to the upstream portion of a vapor phase reactor of the type described in U.S. Pat. No. 3,203,763. Simultaneously, oxygen was heated to 1540° C. and admitted to the same reaction chamber through a separate inlet. Aluminum chloride was added at a rate sufficient to produce 1.1% Al₂O₃ on the collected oxidation reactor discharge. The reactant streams were rapidly mixed. The gaseous suspension containing primarily TiO₂ powder was then quickly cooled.

The material was heated under identical conditions as described in Example 1 in side by side experiments during the same heating cycles. The control sample contained the same amount of aluminum as the sample from Example 1, to within error of measurement.

Particle size distribution measurements were performed using the same procedures described in Example 1. For comparative example 2, a longer sonication time was used (19 minutes) in an attempted to break up any loosely bound large aggregates.

In FIG. 1, the particle size distribution is shown after sonication for 19 minutes (a time beyond which the particle size distribution no longer changes significantly). The particle size distribution of comparative example 1 is shown in purple.

The data shows that the control sample (comparative example 1) exhibits a very broad particle size distribution, with larger, strongly bound aggregates.

These measurements were performed after extensive sonication, which indicates that the aggregates observed in comparative example 1 are hard and not easily broken apart. As can be seen from this data, differences between comparative example 1 and example 1 show the difference in sinterability and demonstrates the improvement of the present invention. The results show powders produced by introducing a silicon halide precursor to the chloride oxidation process of TiCl₄ results in a material with much lower sinterability. These results are in agreement with observations of the physical texture of the heat-treated powders. The material of example 1 appeared to be whiter and more free flowing than the control sample (comparative example 1).

We claim:

1. A process comprising:
a) in a chloride process for forming titanium dioxide, adding silicon halide precursor during oxidation of titanium tetrachloride to form silicon-containing titanium oxide;
b) mixing the silicon-containing titanium dioxide with at least one binder and at least one solvent to form a slurry;
c) spreading the slurry with a doctor blade to form at least one green sheet;
d) laminating at least one green sheet with at least one green sheet of one or more other ceramic materials to form a laminated object containing a surface region of low sinterability material;
e) sintering the laminated object; and
f) removing the surface region of low sinterability material.

2. A laminated object made by the process of claim 1.

3. A process comprising:
a) in a chloride process for forming titanium dioxide, adding silicon halide precursor during oxidation of titanium tetrachloride to form a silicon-containing titanium dioxide;
b) mixing the silicon-containing titanium dioxide with at least one binder and at least one solvent to form a slurry;
c) spreading the slurry with a doctor blade to form at least one green sheet;
d) laminating at least one green sheet with at least one green sheet; of one or more other ceramic materials to form a laminated object containing a surface region of low sinterability material;
e) sintering the laminated object; and
f) impregnating the surface region of low sinterability material with a resin.

4. A laminated object made by the process of claim 3.

5. A process comprising:
a) in a chloride process for forming titanium dioxide, adding silicon halide precursor during oxidation of titanium tetrachloride to form a silicon-containing titanium dioxide;
b) mixing the silicon-containing titanium dioxide with at least one binder and at least one solvent to form a slurry;
c) coating the slurry on a substrate to form a coated substrate;
d) allowing the solvent to evaporate from the slurry to form a dried coated substrate; and
e) sintering the dried coated substrate.

6. A dried coated substrate made by the process of claim 5.
